(19) United States
(12) Patent Application Publication
(10) Pub. No.: US 2002/0186781 A1
(43) Pub. Date: Dec. 12, 2002

(54) Rapid information transmission method

(76) Inventor: Masaaki Usui, Nagano (JP)

Correspondence Address: BEYER WEAVER & THOMAS LLP, P.O. BOX 778, BERKELEY, CA, 94704-0778, US

(21) Appl. No.: 09/851,590

(22) Filed: May 8, 2001

(51) Int. Cl. H04L 25/34

(52) U.S. Cl. 375/286

(57) ABSTRACT

Methods and apparatus are described for transmitting information via a transmission medium. First information represented according to a first number system of a first order is received. The first information is converted to second information, the second information being represented according to a second number system of a second order, the second order being greater than the first order. The second information is then represented using a first number of unique signal characteristics, the first number corresponding to the second order. The second information is then transmitted via the transmission medium.

### BACKGROUND OF THE INVENTION

The present invention relates to methods and apparatus for rapidly transmitting information in a variety of transmission and network media, e.g., telephone networks, the Internet, etc.

Digital technology has been used for transmission and processing of information. In this digital technology, information is handled as digital data employing “1” and “0” or “H” and “L” as the unit bit.

Recently, the number of types of information being transmitted over various media have been increasing and the demand for the quality of such information has intensified such that the overall quantity of information being transmitted has increased dramatically. At the same time that the number of bit digits of digital data representing information has been increasing, e.g., 16, 32, 64 bits, etc., the demand for shorter transmission and processing times and fidelity have also increased such that the bit rate with which information is transmitted has also increased dramatically.

A wide variety of data transmission techniques have been developed to satisfy these demands including methods for decreasing the clock frequencies which determine transmission/processing speed, methods for multiplexing transmissions, and the like. Various data compression technologies have also been proposed and implemented. However, although existing compression technologies are sufficient for some applications, there still exist problems relating to the faithfulness and reliability of information reproduced which make such technologies inappropriate for many applications.

### SUMMARY OF THE INVENTION

The various embodiments of the present invention provide techniques for accurately and rapidly transmitting large amounts of information which address the issues described above. More specifically, the present invention provides methods and apparatus for representing and transmitting information according to an n^{th} order number system where n is a positive integer greater than or equal to 3.

Thus, the present invention provides methods and apparatus for transmitting information via a transmission medium. First information represented according to a first number system of a first order is received. The first information is converted to second information, the second information being represented according to a second number system of a second order, the second order being greater than the first order. The second information is then represented using a first number of unique signal characteristics, the first number corresponding to the second order. The second information is then transmitted via the transmission medium.

The present invention also provides methods and apparatus for receiving information transmitted via a transmission medium. First information is received via the transmission medium, the first information being represented and transmitted using a first number of signal characteristics. Representation of the first information is converted to a first number system of a first order, the first order corresponding to the first number. The first information is converted to second information, the second information being represented according to a second number system of a second order. The second order is less than the first order.

A further understanding of the nature and advantages of the present invention may be realized by reference to the remaining portions of the specification and the drawings.

### BRIEF DESCRIPTION OF THE DRAWINGS

FIG. 1 is a block diagram for an information transmission system for implementing the information transmission method of the present invention;

FIG. 2A is a timing chart for a quaternary-system signal;

FIG. 2B is a timing chart for an output signal of a frequency generator; and

FIG. 2C is a timing chart of an information signal according to a specific embodiment of the invention.

### DETAILED DESCRIPTION OF SPECIFIC EMBODIMENTS

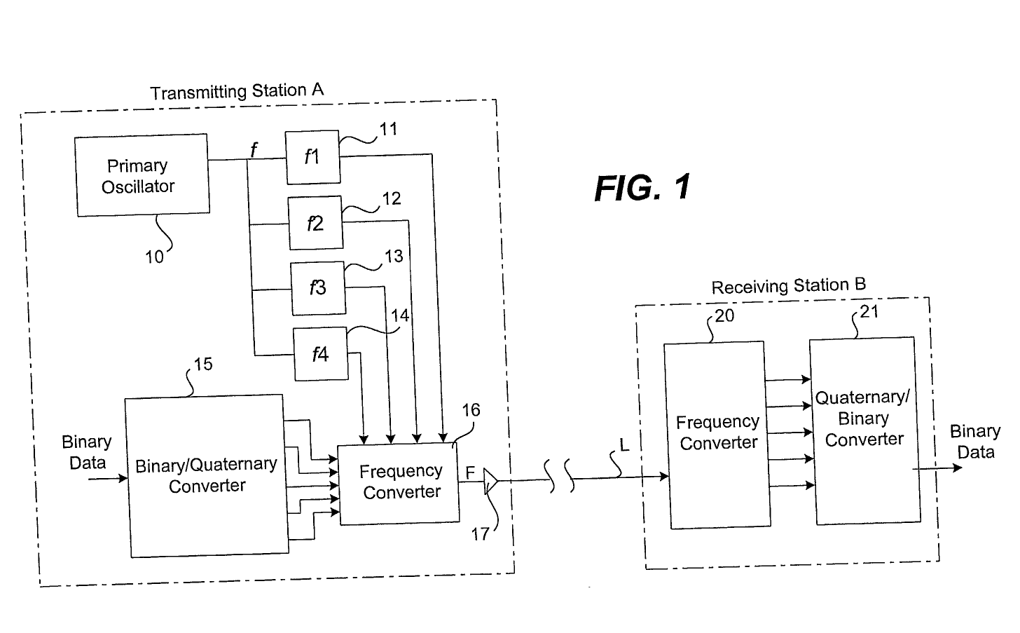

FIG. 1 shows a block diagram of an information transmission system for implementing a specific embodiment of an information transmission method of the present invention.

The information transmission system shown here is a quaternary system for transmitting information from transmitting station A to receiving station B which employs frequency as its signal characteristic value. It will be understood that a variety of other well known signal characteristics may be employed instead of frequency and remain within the scope of the invention.

The transmission station A includes a primary oscillator 10 for oscillating a signal with frequency f (for example, 1 MHz) using, for example, a crystal oscillator. Frequency generators 11, 12, 13, 14 generate frequencies f1, f2, f3, f4 by dividing the signal with the frequency f provided by primary oscillator 10. A binary/quaternary system converter 15 converts binary data consisting of 1s and 0s (e.g., highs and lows) to quaternary-system signals. A frequency converter 16 converts signals outputted from the frequency generators 11, 12, 13, 14 based on the quaternary-system signals outputted from binary/quaternary system converter 15. An amplifier 17 amplifies the output F of frequency converter 16.

The receiving station B includes a frequency converter 20 for converting the frequencies f1, f2, f3, f4 of a received signal to a quaternary-system signals and a quaternary/binary system converter 21 for converting that quaternary-system signal back to the original binary data.

Although the transmission medium between stations A and B may be wire or radio path, it is desirable to provide a medium having a high volume transmission capacity.

According to a specific embodiment of the invention and as shown in FIG. 1, a public telephone line L is used for the transmission medium. Because the frequency band for use is desired to be as small as possible, frequency f1 of the frequencies 11-14 is 697 Hz, f2 is 770 Hz, f3 is 852 Hz and f4 is 941 Hz, thus keeping all of the frequencies within a band of 1 kHz. It will be understood that these particular frequencies and the total band are merely illustrative and should not be used to limit the scope of the invention. In the exemplary binary/quaternary-system described herein, “0” corresponds to f1, “1” to f2, “2” to f3 and “3” to f4.

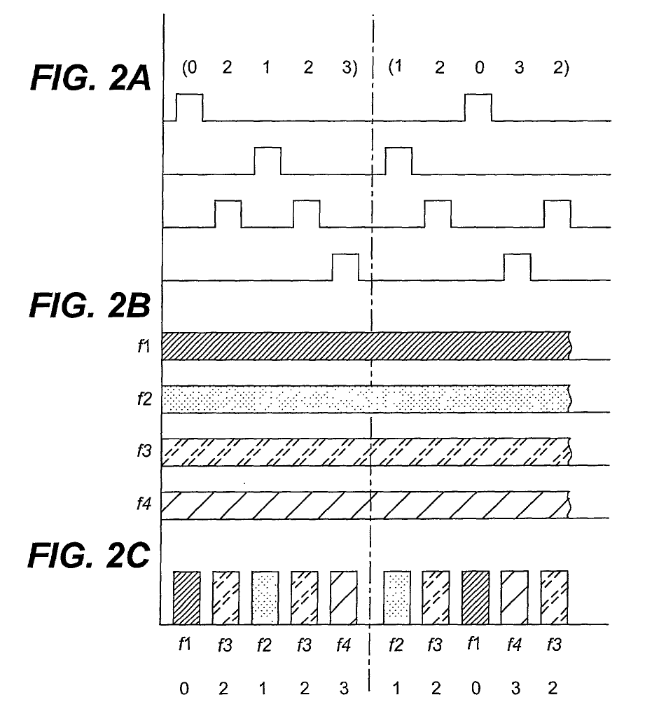

An exemplary operation of the information transmission system of FIG. 1 will now be described with reference to FIGS. 2A, 2B, 2C. Signals with the frequencies f1, f2, f3, f4 are outputted from the frequency generators 11, 12, 13, 14. The outputs from the frequency generators 11, 12, 13, 14 are converted to represent numerals 0, 1, 2, 3 corresponding to the quaternary-system signal outputted from the binary/quaternary system converter 15. This information is then transmitted as information signal F through public telephone line L. The frequencies f1, f2, f3, f4 of information signal F corresponding to numerals of each digit of the quaternary-system signal obtained by conversion of the original binary data.

If as a result of converting binary data to quaternary-system data using converter 15, five-digit quaternary-system signals “02123” and “12032” are obtained as shown in FIG. 2A, the frequencies f1, f2, f3, f4 generated by the frequency generators 11-14 (FIG. 2B) are selected by frequency converter 16 according to the five-digit quaternary-system signals and converted to information signal F which is composed of frequencies f1, f2, f3, f4 as shown in FIG. 2C. The information signal F is then transmitted to the receiving station B through the public telephone line L.

The received information signal F is converted to five-digit quaternary-system signals by the frequency converter 20 at receiving station B and then further converted to the original binary data by the quaternarylbinary converter 21. After that, the binary data are transmitted to a processing circuit or system (not shown).

By achieving information transmission with quaternary-system data instead of the conventional binary data, as compared to a condition of 8 cycles/second, 500 cycles/minute under 50 ms in signal transmission time, 30 ms in minimum pose, 120 ms in cycle, it comes under four lines (L0, H0, H1, H2, H3: L1, H0, H1, H2, H3: L2, H0, H1, H2, H3: L3, H0, H1, H2, H3) per unit time (i.e., per second) that eighth power of 4, multiplied with 4 times/second is 262,144, which is about 128 times/second, thereby enabling a large-quantity information to be transmitted.

Although in the above embodiment, a quaternary system has been exemplified, if an octonary system is applied, comparing under the same condition as above, it comes under two lines (L0, L1, H0, H1, H2, H3: L2, L3, H0, H1, H2, H3) that the eighth power of 8, multiplied with twice/second is 33,554,432, which is about 16,384 times.

A second embodiment of an information transmission method for achieving rapid transmission will now be described.

If low group frequencies L0, L1, L2, L3 and high group frequencies H0, H1, H2, H3 are used as shown in Table 1 and combined with each other as seen in dual tone multiplexed frequency (DTMF) signals composed of 16 kinds of signals, a hexadecimal system implementation of the present invention can be achieved. Under a condition of within frequency error of ±1.5% and signal transmission level of −16.5+0.8 L dB or more to −6.5 +0.8 L or less, transmission through general telephone line is enabled.

As compared to the conventional binary system method, it comes that eighth power of 2, multiplied with eight times/second is 2048 in a condition of 8 cycles/second, 500 cycles/minute under 50 ms in signal transmission time, 30 ms in minimum pose, 120 ms in cycle, according to this embodiment of the present invention (hexadecimal system), it comes that eighth power of 16, multiplied with 1 time/second is 4,294,967,296 under a line (L0, L1, L2, L3, H0, H1, H2, H3). As a result, as compared to the conventional binary system transmission, transmission with information in the amount of about 2,097,152 times/second is enabled.

TABLE 1

| Frequency | 697 Hz | 770 Hz | 852 Hz | 941 Hz |
|---|---|---|---|---|
| Notation digit | L0 | L1 | L2 | L3 |
| Frequency | 1209 Hz | 1336 Hz | 1477 Hz | 1633 Hz |
| Notation digit | H0 | H1 | H2 | H3 |
| | H0 | H1 | H2 | H3 |
| L0 | 0 | 4 | 8 | C |
| L1 | 1 | 5 | 9 | D |
| L2 | 2 | 6 | A | E |
| L3 | 3 | 7 | B | F |

It will be understood that although the present invention has been described with reference to quaternary and hexadecimal techniques, the scope of invention encompasses any nth order system technique (n being a positive integer greater than or equal to 3). Under any order system technique of the present invention, far more information can be transmitted and at greater speeds than with conventional binary system techniques.

For notation of the n system method for information to be transmitted according to the present invention, numeral, symbol and character, namely alphanumeric notation or a combination therewith is preferable.

Further, the transmission method of the present invention is also capable of providing with security function.

According to the exemplary embodiments described above, quaternary or hexadecimal system data are converted to combinations of frequencies. However, the present invention should not be so limited. As mentioned above, a variety of different signal characteristic values may be employed to represent the n^{th} order system data including, for example, amplitude, phase, pulse width, frequency, and in case of optical signals, wavelength of light.

While the invention has been particularly shown and described with reference to specific embodiments thereof, it will be understood by those skilled in the art that changes in the form and details of the disclosed embodiments may be made without departing from the spirit or scope of the invention. In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A method for transmitting information via a transmission medium, comprising:
receiving first information represented according to a first number system of a first order;
converting the first information to second information, the second information being represented according to a second number system of a second order, the second order being greater than the first order;
representing the second information using a first number of unique signal characteristics, the first number corresponding to the second order; and
transmitting the second information via the transmission medium.

2. The method of claim 1 wherein the first number system is a binary number system.

3. The method of claim 2 wherein the second number system is a ternary number system.

4. The method of claim 2 wherein the second number system is a quaternary number system.

5. The method of claim 2 wherein the second number system is a hexadecimal number system.

6. The method of claim 2 wherein the second number system comprises an n^{th} order number system where n is greater than or equal to three.

7. The method of claim 1 wherein each of the unique signal characteristics comprises a unique frequency.

8. The method of claim 1 wherein the transmission medium comprises a wide area network.

9. The method of claim 1 wherein at least a portion of the transmission medium comprises telephone transmission lines.

10. A method for receiving information transmitted via a transmission medium, comprising:
receiving first information via the transmission medium, the first information being represented and transmitted using a first number of signal characteristics;
converting representation of the first information to a first number system of a first order, the first order corresponding to the first number; and
converting the first information to second information, the second information being represented according to a second number system of a second order, the second order being less than the first order.

11. The method of claim 10 wherein the second number system is a binary number system.

12. The method of claim 11 wherein the first number system is a ternary number system.

13. The method of claim 11 wherein the first number system is a quaternary number system.

14. The method of claim 11 wherein the first number system is a hexadecimal number system.

15. The method of claim 11 wherein the first number system comprises an n^{th} order number system where n is greater than or equal to three.

16. The method of claim 10 wherein each of the unique signal characteristics comprises a unique frequency.

17. The method of claim 10 wherein the transmission medium comprises a wide area network.

18. The method of claim 10 wherein at least a portion of the transmission medium comprises telephone transmission lines.

19. A system for transmitting information via a transmission medium, comprising a transmitting station configured to receive first information represented according to a first number system of a first order, convert the first information to second information, the second information being represented according to a second number system of a second order, the second order being greater than the first order, represent the second information using a first number of unique signal characteristics, the first number corresponding to the second order, and transmit the second information via the transmission medium.

20. A system for receiving information transmitted via a transmission medium, comprising a receiving station configured to receive first information via the transmission medium, the first information being represented and transmitted using a first number of signal characteristics, convert representation of the first information to a first number system of a first order, the first order corresponding to the first number, and convert the first information to second information, the second information being represented according to a second number system of a second order, the second order being less than the first order.
